(19) United States
(12) Patent Application Publication
(10) Pub. No.: US 2026/0169500 A1
(43) Pub. Date: Jun. 18, 2026

(54) METHODS AND SYSTEMS FOR DETERMINING ROBOT DRIVING MODE

(71) Applicant: NAVER CORPORATION, Seongnam-si (KR)

(72) Inventors: Seunghwan CHUNG, Seongnam-si (KR); Jinyoung CHOI, Seongnam-si (KR); Keonwoo KIM, Seongnam-si (KR); Seulbin HWANG, Seongnam-si (KR); Hyunseok KIL, Seongnam-si (KR); Jaejung BYUN, Seongnam-si (KR)

(73) Assignee: NAVER CORPORATION, Seongnam-si (KR)

(21) Appl. No.: 19/532,591

(22) Filed: Feb. 6, 2026

Related U.S. Application Data
(63) Continuation of application No. PCT/KR2024/002940, filed on Mar. 7, 2024.

(30) Foreign Application Priority Data
Aug. 8, 2023 (KR) 10-2023-0103748

(51) Int. Cl. G05D 1/65; G05D 1/24; G05D 1/617; G05D 101/00; G05D 109/10; G05D 111/10; G05D 111/30

(52) U.S. Cl. CPC G05D 1/65; G05D 1/24; G05D 1/617; G05D 2101/22; G05D 2109/10; G05D 2111/10; G05D 2111/32

(57) ABSTRACT

The present disclosure provides a method for determining a robot driving mode, the method being performed by at least one processor of a robot. This method includes transmitting, to a server, an image captured by a camera of the robot and a query associated with the image, receiving, from the server, a response to the query on the basis of a visual language model, and determining the driving mode of the robot on the basis of the response.

### CROSS-REFERENCE TO RELATED APPLICATIONS

This U.S. non-provisional application is a continuation of, and claims the benefit of priority under 35 U.S.C. § 365(c) from International Patent Application No. PCT/KR2024/002940 filed on Mar. 7, 2024 in the World Intellectual Property Organization (WIPO), which designates the United States of America and claims priority from Korean Patent Application No. 10-2023-0103748 filed on Aug. 8, 2023, the disclosures of each of which are herein incorporated by reference.

### TECHNICAL FIELD

The present disclosure relates to a method and system for determining a robot driving mode, and specifically, to a method and system for transmitting, to a server, an image captured by a robot and a query associated with the image, and for determining the driving mode of the robot, based on a response to the query generated using a zero-shot-based visual language model.

### BACKGROUND

An autonomous driving robot may refer to a robot that may autonomously drive by recognizing a surrounding environment using radar, Light Detection and Ranging (LIDAR), GPS, a camera, and the like. Recently, by using autonomous driving robot technology, various autonomous driving robot services for providing a service to a person are being developed and utilized.

An ideal driving method of a robot may be different according to characteristics of an environment. For example, when a dynamic object such as a person is present in the environment, a robot needs (or attempts) to move while avoiding (or attempting to avoid) the dynamic object, and, in an environment in which only robots are present, a robot needs (or attempts) to move accurately according to a path set so as not to collide with other robots. A conventional driving method involves moving in a specific area according to a specific driving method. However, the lack of flexibility of the conventional method in changing the driving method according to a dynamic situation results in reduced driving efficiency.

### SUMMARY

To address the challenges described above, the present disclosure provides a method for determining a robot driving mode and a robot.

The present disclosure may be implemented in various manners including a method, a device (system), or a non-transitory computer-readable storage medium storing a computer program.

According to some example embodiments of the present disclosure, a method for determining a robot driving mode may include transmitting, to a server, an image captured by a camera of a robot and a query associated with the image, receiving, from the server, a response to the query based on a visual language model, and determining a driving mode of the robot based on the response.

A non-transitory computer-readable non-transitory recording medium may record instructions that, when executed by a computer, cause the computer to perform the method according to some example embodiments of the present disclosure.

According to some example embodiments of the present disclosure, a robot may be provided. The robot may include a communication module, a memory, a display, and at least one processor connected to the memory, the at least one processor being configured to execute at least one computer-readable program included in the memory to cause the robot to transmit, to a server, an image captured by a camera of the robot and a query associated with the image, receive, from the server, a response to the query based on a visual language model, and determine a driving mode of the robot based on the response.

According to some example embodiments of the present disclosure, by using a zero-shot-based visual language model, even when a new dynamic object exists, the robot may understand a situation without learning. In addition, the robot may recognize a current situation and may flexibly switch a driving mode. Accordingly, driving efficiency of the robot may be improved.

According to some example embodiments of the present disclosure, without learning a new dynamic object, by using a zero-shot-based visual language model applicable to an actual environment, the robot may understand surrounding situations of the robot. Accordingly, by determining and switching an appropriate driving mode according to a situation, driving efficiency of the robot may be improved, and a collision risk of the robot may be reduced.

According to some example embodiments of the present disclosure, by using a zero-shot-based visual language model, even when the robot drives in a new environment, the driving mode may be appropriately switched.

According to some example embodiments of the present disclosure, by communicating with a server using a zero-shot-based visual language model, real-time switching of the driving mode is possible.

The effects of the present disclosure are not limited to the effects mentioned above, and other effects not mentioned may be clearly understood, for example, based on the features of the claims, by a person having ordinary knowledge in a technical field to which the present disclosure belongs (referred to as “a person having ordinary skill in the art”).

### BRIEF DESCRIPTION OF DRAWINGS

Some example embodiments of the present disclosure will be described with reference to the drawings described below, where like reference numerals denote like elements, but are not limited thereto.

FIG. 1 illustrates an example of a method for determining a robot driving mode according to some example embodiments of the present disclosure.

FIG. 2 is an overview diagram illustrating a configuration in which a plurality of robots and an information processing system are connected so as to be communicable through a network.

FIG. 3 is a block diagram illustrating an internal configuration of a robot and an information processing system according to some example embodiments of the present disclosure.

FIG. 4 is a diagram illustrating an example of a driving mode determination factor according to some example embodiments of the present disclosure.

FIG. 5 is a diagram illustrating an example in which the driving mode of a robot is determined according to some example embodiments of the present disclosure.

FIG. 6 is a diagram illustrating an example of a response table according to some example embodiments of the present disclosure.

FIG. 7 is a diagram illustrating an example in which the driving mode of a robot is determined according to some example embodiments of the present disclosure.

FIG. 8 is a diagram illustrating an example in which the driving mode of a robot is determined according to some example embodiments of the present disclosure.

FIG. 9 is a diagram illustrating an example in which the driving mode of a robot is determined according to some example embodiments of the present disclosure.

FIG. 10 is a flowchart illustrating an example of a method according to some example embodiments of the present disclosure.

### DETAILED DESCRIPTION

Hereinafter, specific contents for implementing the present disclosure will be described in detail with reference to the attached drawings. However, in the following description, specific descriptions regarding well-known functions or configurations will be omitted if they would unnecessarily obscure the gist of the present disclosure.

In the attached drawings, the same (or similar) or corresponding components are assigned the same (or similar) reference numerals. In addition, in the descriptions of the examples below, descriptions of the same (or similar) or corresponding components may be omitted to avoid (or reduce) redundancy. However, even if the description regarding a component is omitted in a given example, it is not intended that the component is omitted from every implementation of the given example.

The advantages and features of the disclosed examples, and methods for achieving the examples, will become apparent with reference to the examples described below together with the attached drawings. However, the present disclosure is not limited to the examples disclosed below, but may be implemented in various other forms, and the examples are merely provided to make the present disclosure complete and to fully convey the scope of the inventive concepts to those skilled in the art.

Terms used in this specification will be briefly described, and the disclosed examples will be described in detail. The terms used in the specification are selected from general terms currently widely used in the art in consideration of functions in the present disclosure, but the terms may vary according to the intention of those skilled in the art, precedents, new technology in the art, or the like. In addition, in specific cases, there are terms selected (or devised) by the applicant, and in this case, the meaning of the terms will be described in detail in the description of the corresponding inventive concepts. Therefore, the terms used in the present disclosure should be defined based on the meaning of the terms and the overall contents of the present disclosure, not just the names of the terms.

In this specification, singular expressions shall be understood to include plural expressions unless clearly specified as singular in the context. In addition, plural expressions shall be understood to include singular expressions unless clearly specified as plural in the context. Throughout the specification, unless explicitly described to the contrary, the word “comprise/include” and variations such as “comprises/includes” or “comprising/including” will be understood to imply the further inclusion of stated elements but not the exclusion of any other elements.

Further, the terms “module” or “unit” used in the specification refer to hardware components or a combination of hardware and software components, and the “module” or “unit” performs specific roles. However, the “module” or “unit” is not limited to software or hardware. The term “module” or “unit” may be configured to be in a non-transitory addressable storage medium or configured to reproduce one or more processors. Therefore, as an example, the “module” or “unit” may include at least one of components such as software components, object-oriented software components, class components, and task components, processes, functions, attributes, procedures, subroutines, segments of program code, drivers, firmware, microcode, circuits, data, databases, data structures, tables, arrays, or variables. The functions provided in the components and “modules” or “units” may be combined into a smaller number of components and “modules” or “units” or may be further divided into additional components and “modules” or “units”.

According to some example embodiments of the present disclosure, “module” or “unit” may be implemented by processing circuitry. The term “processing circuitry” as used in the present disclosure should be broadly interpreted to refer to, for example, hardware including logic circuits; a hardware/software combination such as a processor executing software; or a combination thereof. For example, the processing circuitry more specifically may include, but is not limited to, a general-purpose processor, a Central Processing Unit (CPU), an Arithmetic Logic Unit (ALU), a Graphics Processing Unit (GPU), a microprocessor, a Digital Signal Processor (DSP), a controller, a microcontroller, a microcomputer, a state machine, an Application-Specific Integrated Circuit (ASIC), a Programmable Logic Device (PLD), a Field-Programmable Gate Array (FPGA), a System-on-Chip (SOC), a programmable logic unit, or the like. The “processing circuitry” may, for example, refer to a combination of processing devices such as a combination of a DSP and a microprocessor, a combination of multiple microprocessors, a combination of one or more microprocessors coupled with a DSP core, or a combination of any other such configuration.

According to some example embodiments of the present disclosure, “module” or “unit” may be implemented by a processor and memory. The “memory” should be broadly interpreted to include any electronic component capable of storing electronic information. The “memory” may refer to various types of processor-readable media such as a Random Access Memory (RAM), a Read-Only Memory (ROM), a Non-Volatile Random Access Memory (NVRAM), a Programmable Read-Only Memory (PROM), an Erasable and Programmable Read-Only Memory (EPROM), an Electrically Erasable PROM (EEPROM), a flash memory, a magnetic or optical data storage device, registers, and the like. If the processor may read information from the memory and/or write information to the memory, the memory is said to be in a state of electronic communication with the processor. The memory integrated with the processor is in a state of electronic communication with the processor.

In the present disclosure, the “system” may include at least one of a server device or a cloud device, but is not limited thereto. For example, the system may be composed of one or more server devices. As another example, the system may be composed of one or more cloud devices. As yet another example, the system may be configured such that the server device and the cloud device operate together.

In the present disclosure, “a server”, “a system”, and “an information processing system” are devices communicable with a plurality of robots, and may be used with the same meaning as (or a similar meaning to) each other.

In the present disclosure, the “display” may refer to any display device associated with a computing device, and may refer to any display device capable of displaying information/data provided or controlled by the computing device, for example.

In the present disclosure, the expression “each of a plurality of A” may refer to each of all the components included in the plurality of A, or each of some of the components included in the plurality of A.

In the present disclosure, a “machine learning model” may include any model used to infer an answer (e.g., solution, response) for a given input. According to some example embodiments, the machine learning model may include an artificial neural network model including an input layer, a plurality of hidden layers, and an output layer. Here, each layer may include a plurality of nodes. In the present disclosure, although each of a plurality of machine learning models is described as a separate machine learning model, the present disclosure is not limited thereto, and some or all of the plurality of machine learning models may be implemented as one machine learning model. In addition, one machine learning model may include a plurality of machine learning models. In the present disclosure, the terms machine learning model and artificial neural network model may be used interchangeably to refer to the same model or similar models.

In the present disclosure, “visual language model” may refer to a machine learning model or an artificial neural network model configured to understand and process visual data such as an image. A visual language model may be pre-trained (or trained) to describe visual information extracted from an image or a video in a natural language, or to generate visual content through a natural language description.

In the present disclosure, “zero-shot-based visual language model” may refer to a visual language model learning from a small amount of labeled data or unlabeled data. A zero-shot-based visual language model may extract pre-trained (or trained) features for a visual language task by using a pre-trained (or trained) model, and may learn, for a new domain or a new task, even from unlabeled data, by applying such features to the new visual language task.

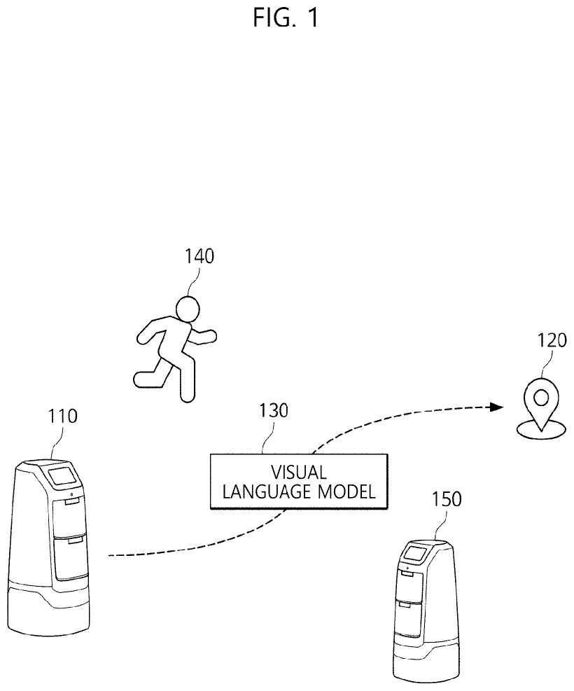

FIG. 1 illustrates an example of a method for determining a robot driving mode according to some example embodiments of the present disclosure. In some example embodiments, a robot 110 may autonomously drive to a destination 120. Specifically, the robot 110 may determine a driving path to the destination 120 based on absolute position information, and may autonomously drive according to the driving path.

In some example embodiments, the robot 110 may transmit, to a server, an image of a surrounding environment captured by a camera while driving, and a query associated with the image. Here, the query includes a query about a driving mode determination factor. For example, the driving mode determination factor may include whether a pedestrian exists, whether another robot exists, whether a landmark exists, whether a width of a passage is narrower than a predetermined (or otherwise, given) value, whether a social distance between the robot and a person is smaller than a predetermined (or otherwise, given) value, and the like.

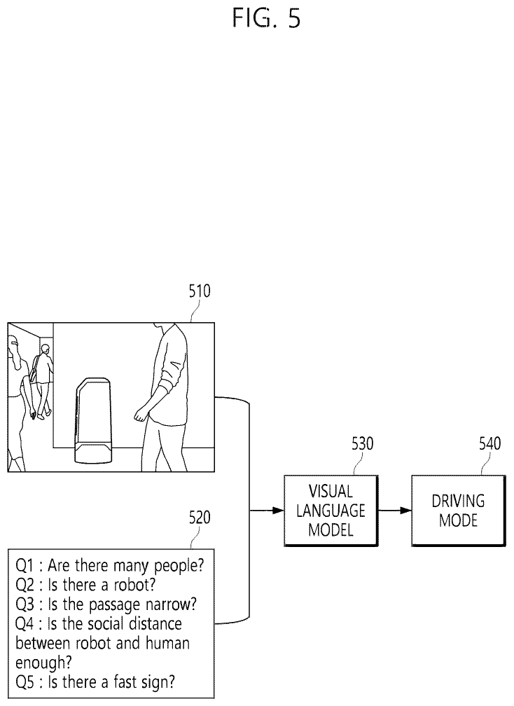

In some example embodiments, the server may generate a response to the query, based on the image and the query received from the robot 110, by using a visual language model 130. According to some example embodiments, the visual language model 130 may be implemented as a zero-shot-based visual language model and may be referred to herein as the zero-shot-based visual language model 130. For example, because a passing pedestrian 140 and another robot 150 are present (e.g., depicted) in the image received from the robot 110, a response that driving needs to (or is to) be performed more slowly than a reference speed may be generated. An example in which the response is generated is described later in detail with reference to FIG. 5 to FIG. 8.

In some example embodiments, the response may be generated based on an operation of a specific object in the image. For example, when a person in the image is sitting, the person is not a dynamic object, and may be excluded from (or as) a consideration target. In addition, the response may be generated based on a characteristic of a specific object in the image. For example, the visual language model 130 may recognize that a person in the image is an elderly person or a young child, and may generate a response that driving needs to (or is to) be performed in a preset (or alternatively, given) driving mode (for example, slow mode).

In some example embodiments, the robot 110 may determine a driving mode based on the response received from the server. In this case, the robot 110 may determine any one among a plurality of preset (or alternatively, given) driving modes. Here, at least one of a driving speed of the robot or an autonomous driving allowance level of the robot may be different in each of the plurality of driving modes. For example, the plurality of preset (or alternatively, given) driving modes may include an autonomous driving mode (autonomous mode) that drives more slowly than a reference speed, a strict driving mode (strict mode) that drives along a determined path, a follow mode that moves along a wall, a fast mode that drives faster than the reference speed, and the like, but is not limited thereto, and may include various modes in which a driving speed and an autonomous driving allowance level are combined, such as a fast strict driving mode (fast strict mode). Additionally, when the robot 110 receives, from the server, the same response (or similar responses) a predetermined (or alternatively, given) number of times (for example, 10 times), the robot 110 may also determine a driving mode.

Through such a configuration, by using a zero-shot-based visual language model, even when a new dynamic object exists, the robot may understand a situation without learning. In addition, the robot may recognize a current situation and may flexibly switch a driving mode. Accordingly, driving efficiency of the robot may be improved. Furthermore, by determining a driving mode only when the same response is (or similar responses are) received at least the predetermined (or alternatively, given) number of times, the driving mode may be more accurately determined.

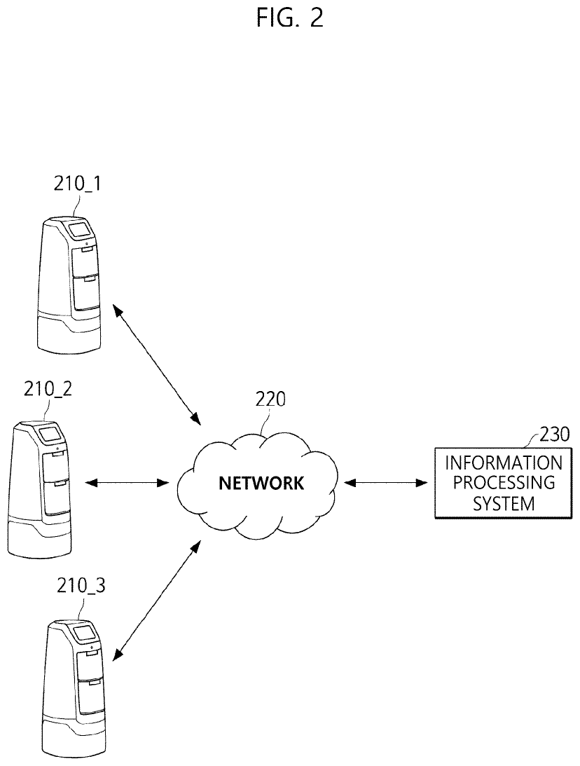

FIG. 2 is an overview diagram illustrating a configuration in which a plurality of robots 210_1, 210_2, and 210_3 and an information processing system 230 are connected so as to be communicable through a network 220. The information processing system 230 may correspond to a server according to some example embodiments, and may be configured to control movement and/or operation of the plurality of robots 210_1, 210_2, and 210_3 through the network 220.

According to some example embodiments, the information processing system 230 may include one or more server devices and/or a database, or one or more distributed computing devices and/or a distributed database based on a cloud computing service, which may store, provide, and execute a computer-executable program (for example, a downloadable application) and data related to controlling movement and/or operation of the plurality of robots 210_1, 210_2, and 210_3. The information processing system 230 may be located inside a building in which the robot 210 is located, or may be located outside the building.

The plurality of robots 210_1, 210_2, and 210_3 may drive inside the building, and may communicate with the information processing system 230 through the network 220. The network 220 may be configured such that communication between the plurality of robots 210_1, 210_2, and 210_3 and the information processing system 230 is possible. The network 220 may, according to an installation environment, be configured as, for example, a wired network 220 such as Ethernet, a wired home network (Power Line Communication), a telephone line communication device, and RS-serial communication, a mobile communication network, a wireless network 220 such as Wireless Local Area Network (WLAN), Wi-Fi, Bluetooth, and ZigBee, or a combination thereof. A communication method is not limited, and may include not only a communication method utilizing a communication network (for example, a mobile communication network, a wired Internet, a wireless Internet, a broadcasting network, a satellite network, and the like) which the network 220 may include, but also short-range wireless communication between the plurality of robots 210_1, 210_2, and 210_3. For example, the network 220 may include any one or more networks among network 220 such as a Personal Area Network (PAN), a Local Area Network (LAN), a Campus Area Network (CAN), a Metropolitan Area Network (MAN), a Wide Area Network (WAN), a Broadband Network (BBN), the Internet, and the like. In addition, the network 220 may include any one or more among network topologies including a bus network, a star network, a ring network, a mesh network, a star-bus network, a tree network, hierarchical network, or the like, but is not limited thereto.

In FIG. 2, the plurality of robots 210_1, 210_2, and 210_3 may be any robots capable of wireless communication and capable of autonomous driving. In addition, in FIG. 2, three robots 210_1, 210_2, and 210_3 are illustrated as communicating with the information processing system 230 through the network 220, but some example embodiments are not limited thereto, and a different number of robots 210_1, 210_2, and 210_3 may be configured to communicate with the information processing system 230 through the network 220.

According to some example embodiments, the information processing system 230 may receive image information or text information from at least one robot 210_1, 210_2, and 210_3. And then, the information processing system 230 may transmit, to the robots 210_1, 210_2, and 210_3, information associated with a driving mode of the robots 210_1, 210_2, and 210_3.

According to some example embodiments, the information processing system 230 may generate a response to a query, based on an image received from the robots 210_1, 210_2, and 210_3 and a query associated with the image, by using a zero-shot-based visual language model. In this case, the robots 210_1, 210_2, and 210_3 may determine a driving mode based on a response received from the information processing system 230.

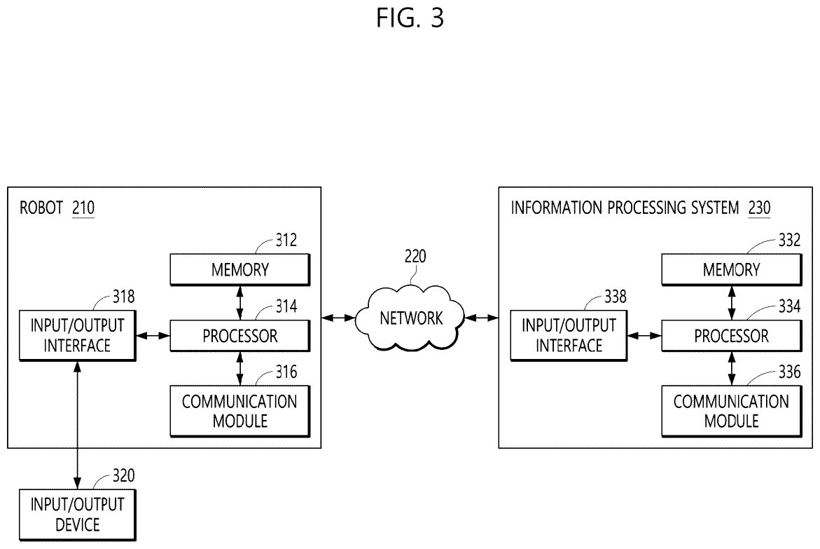

FIG. 3 is a block diagram illustrating an internal configuration of a robot 210 and an information processing system 230 according to some example embodiments of the present disclosure. The robot 210 may refer to any driving device capable of executing a service application using a robot, and capable of wired/wireless communication and autonomous driving, and may include, for example, the robots 210_1, 210_2, and 210_3 of FIG. 2, and the like. As illustrated, the robot 210 may include a memory 312, a processor 314, a communication module 316, and/or an input/output interface 318. Similarly, the information processing system 230 may include a memory 332, a processor 334, a communication module 336, and/or an input/output interface 338. As illustrated in FIG. 3, the robot 210 and the information processing system 230 may be configured to communicate information and/or data through the network 220 by using the communication module 316 and the communication module 336, respectively. In addition, an input/output device 320 may be configured to input information and/or data to the robot 210 through the input/output interface 318, or to output information and/or data generated from the robot 210. According to some example embodiments, operations described herein as being performed by the robot 210, the processor 314, the communication module 316, the input/output interface 318, the information processing system 230, the processor 334, the communication module 336, the input/output interface 338, and/or the input/output device 320 may be performed by processing circuitry.

The information processing system 230 may include various processors (for example, GPU, CPU, and the like) and a memory for implementing a zero-shot-based visual language model. The information processing system 230 may generate a response to an image and/or text received from the robot 210 by utilizing a zero-shot-based visual language model. The information processing system 230 may transmit the generated response to the robot 210.

Each of the memory 312 and the memory 332 may include any non-transitory computer-readable recording medium. According to some example embodiments, each of the memory 312 and the memory 332 may include a permanent mass storage device such as a Read Only Memory (ROM), a disk drive, a Solid State Drive (SSD), a flash memory, etc. As another example, non-volatile permanent mass storage devices such as ROM, SSD, flash memory, a disk drive, etc., may be included in the robot 210 or the information processing system 230 as separate permanent storage devices distinguished from the memory. In addition, an operating system and at least one program code (for example, codes for a service application using a robot installed and driven in the robot 210, or a robot control application installed and driven in the information processing system 230, and the like) may be stored in each of the memory 312 and the memory 332.

Such software components may be loaded from a non-transitory computer-readable recording medium in a separate computer distinguished from the memory 312 and the memory 332. Such a separate non-transitory computer-readable recording medium may include a recording medium directly connectable to the robot 210 and the information processing system 230, and may include, for example, non-transitory computer-readable recording media such as a floppy drive, a disk, a tape, a DVD/CD-ROM drive, a memory card, etc. As another example, software components may also be loaded into the memory 312 and the memory 332 through a communication module, rather than through a non-transitory computer-readable recording medium. For example, at least one program may be loaded into the memory 312 and the memory 332 based on a computer program installed by files provided, through the network 220, by developers or by a file distribution system distributing an installation file of an application.

The processor 314 and the processor 334 may be configured to process instructions of a computer program by performing basic arithmetic, logic, and input/output operations. The instructions may be provided to the processor 314 and the processor 334 by the memory 312 and the memory 332 or the communication module 316 and the communication module 336. For example, the processor 314 and the processor 334 may be configured to execute instructions received according to program code stored in a recording device such as the memory 312 and the memory 332.

The communication module 316 and the communication module 336 may provide a configuration or a function for the robot 210 and the information processing system 230 to communicate with each other through the network 220, and may provide a configuration or a function for the robot 210 and/or the information processing system 230 to communicate with another robot or another system (for example, a separate cloud system and the like). By way of example, information (for example, a captured image, a query associated with a driving mode) generated by the processor 314 of the robot 210 according to program code stored in a recording device such as the memory 312 may be delivered to the information processing system 230 through the network 220 under control of the communication module 316. Conversely, a control signal or an instruction provided under control of the processor 334 of the information processing system 230 may be received in the robot 210 through the communication module 336 and the network 220, and through the communication module 316 of the robot 210. For example, the robot 210 may receive, through the communication module 316, a response to a query and the like from the information processing system 230.

The input/output interface 318 may be means for an interface with the input/output device 320. As one example, an input device may include devices such as a camera including an image sensor, a keyboard, a microphone, a mouse, etc., and an output device may include devices such as a display, a speaker, a haptic feedback device, etc. As another example, the input/output interface 318 may be means for an interface with a device in which a configuration or a function for performing input and output is integrated into one, such as a touch screen and the like. For example, in processing instructions of a computer program loaded in the memory 312 by the processor 314 of the robot 210, a service screen and the like configured by using information and/or data provided by the information processing system 230 or another robot 210 may be displayed on a display through the input/output interface 318. In FIG. 3, the input/output device 320 is illustrated not to be included in (e.g., to be external to) the robot 210, but some example embodiments are not limited thereto, and the input/output device 320 may be configured as one device with the robot 210. In addition, the input/output interface 338 of the information processing system 230 may be means for an interface with a device (not illustrated) for input or output which is connected to the information processing system 230 or which the information processing system 230 may include. In FIG. 3, the input/output interface 318 and the input/output interface 338 are illustrated as elements configured separately from the processor 314 and the processor 334, but some example embodiments are not limited thereto, and the input/output interface 318 and the input/output interface 338 may be configured to be included in the processor 314 and the processor 334, respectively.

The robot 210 and the information processing system 230 may include more elements than the elements of FIG. 3. However, there is no necessity to illustrate such elements in detail. According to some example embodiments, the robot 210 may be implemented to include at least a part of the above-described input/output device 320. In addition, the robot 210 may further include other elements such as a transceiver, a Global Positioning System (GPS) module, a camera, various sensors, a database, and the like. For example, for autonomous driving, the robot 210 may include elements included in the robot, and for example, the robot 210 may be implemented such that a variety of constituent elements such as various sensors including an acceleration sensor, an ultrasonic sensor, a gyroscopic sensor, a proximity sensor, a weight detection sensor, a depth camera, LiDAR, a camera module, various physical buttons, a button using a touch panel, an input/output port, a vibrator for vibration, and the like, may be further included in the robot 210.

According to some example embodiments, the processor 314 of the robot 210 may be configured to autonomously drive under control of the information processing system 230. In this case, program code associated with the foregoing may be loaded in the memory 312 of the robot 210. While the robot 210 drives, the processor 314 of the robot 210 may receive information and/or data provided from the input/output device 320 through the input/output interface 318, or may receive information and/or data from the information processing system 230 through the communication module 316, and may process the received information and/or data and store the received information and/or data in the memory 312. In addition, the information and/or data may be provided to the information processing system 230 through the communication module 316.

While the robot drives, the processor 314 may receive text, an image, a video, a voice, and the like input or selected through input devices (e.g., included in the input/output device 320) such as a touch screen, a keyboard, an audio sensor, and/or a camera including an image sensor connected to the input/output interface 318, a microphone, and the like, and may store the received text, image, video, and/or voice and the like in the memory 312, or may provide the received text, image, video, and/or voice and the like to the information processing system 230 through the communication module 316 and the network 220. For example, the processor 314 may receive information about user authentication, and the like, through input devices such as a touch screen and a keyboard. Accordingly, the received request and/or information may be provided to the information processing system 230 through the communication module 316 and the network 220.

The processor 314 of the robot 210 may be configured to manage, process, and/or store information and/or data received from the input/output device 320, another robot, the information processing system 230, and/or a plurality of external systems. Information and/or data processed by the processor 314 may be provided to the information processing system 230 through the communication module 316 and the network 220. The processor 314 of the robot 210 may output information and/or data by transmitting the information and/or data to the input/output device 320 through the input/output interface 318. For example, the processor 314 may also display the received information and/or data on a screen of the robot 210.

The processor 334 of the information processing system 230 may be configured to manage, process, and/or store information and/or data received from a plurality of robots 210 and/or a plurality of external systems (for example, a terminal used by a user of the robot 210). Information and/or data processed by the processor 334 may be provided to the robot 210 through the communication module 336 and the network 220. In FIG. 3, the information processing system 230 is illustrated as a single system, but the information processing system 230 not limited thereto, and may be configured as a plurality of systems/servers.

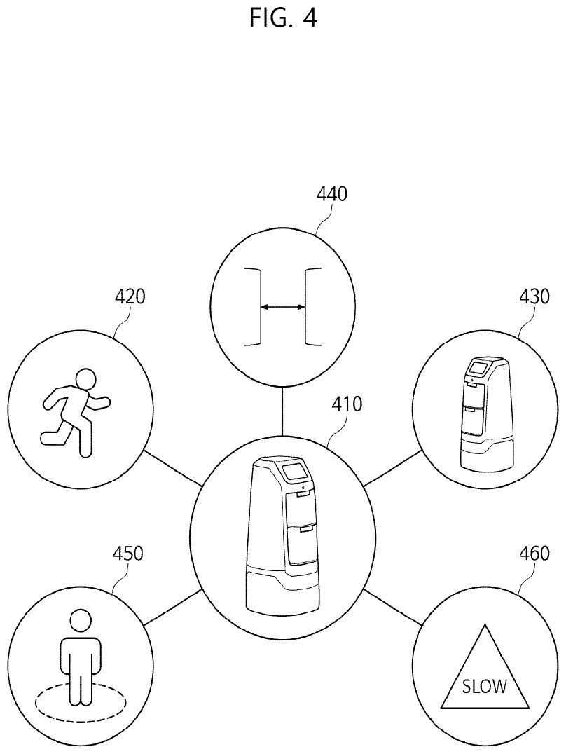

FIG. 4 is a diagram illustrating an example of a driving mode determination factor according to some example embodiments of the present disclosure. In some example embodiments, while a robot 410 drives, various factors for determining a driving mode may exist. For example, the driving mode determination factor may include whether a person exists (or is present) 420, whether a robot exists (or is present) 430, whether a width of a passage is narrower than a predetermined (or alternatively, given) value 440, whether a social distance between the robot and a person is smaller than a predetermined (or alternatively, given) value 450, whether a landmark exists (or is present) 460, and the like. Specifically, when a person or another robot exists (or is present) in a driving path of the robot 410, because a collision risk with the robot 410 exists, a driving speed needs to (or should) be adjusted (e.g., slowed). In addition, when a width of a passage is narrow, a driving speed needs to (or should) be adjusted (e.g., slowed) such that the robot 410 does not collide with walls on both sides. Additionally, because a person may feel anxiety and/or discomfort due to a nearby robot, a driving speed needs to (or should) be adjusted (e.g., slowed) such that a social distance between the robot 410 and a person is maintained. Further, when a specific landmark (for example, a “slow” signboard and the like) exists, a driving speed of the robot 410 needs to (or should) be adjusted to comply with a social rule or a rule of a robot network. Therefore, according to the driving mode determination factor, any one among a plurality of driving modes may be determined. In FIG. 4, the driving mode determination factors are illustrated as five, but some example embodiments are not limited thereto, and factors capable of affecting a driving mode may be further added, and/or one or more of the above factors may be deleted.

FIG. 5 is a diagram illustrating an example in which a driving mode 540 of a robot is determined according to some example embodiments of the present disclosure. In some example embodiments, the robot may capture an image 510 by using a camera, and may transmit the image 510 to the information processing system 230 or a server. In addition, the robot may transmit a query 520 associated with the image 510 to the information processing system 230 or the server. Here, the query 520 may be associated with a driving mode determination factor. For example, the query 520 may include questions associated with the driving mode determination factor, such as, in the image 510, “Are there many people?” (additionally or alternatively, “Are there any people?), “Is there a robot?”, “Is the passage narrow?”, “Is the social distance between robot and human enough?”, “Is there a fast sign?” (additionally or alternatively, “Is there a slow sign?”), and the like.

In some example embodiments, a zero-shot-based visual language model 530 may generate a response based on the image 510 and the query 520. For example, the visual language model 530 may generate an answer (for example, yes/no) to each of a plurality of questions included in the query 520. Here, the visual language model 530 may include a Visual Question Answering (VQA) model, a large language-and-vision model (LLVM), but is not limited thereto.

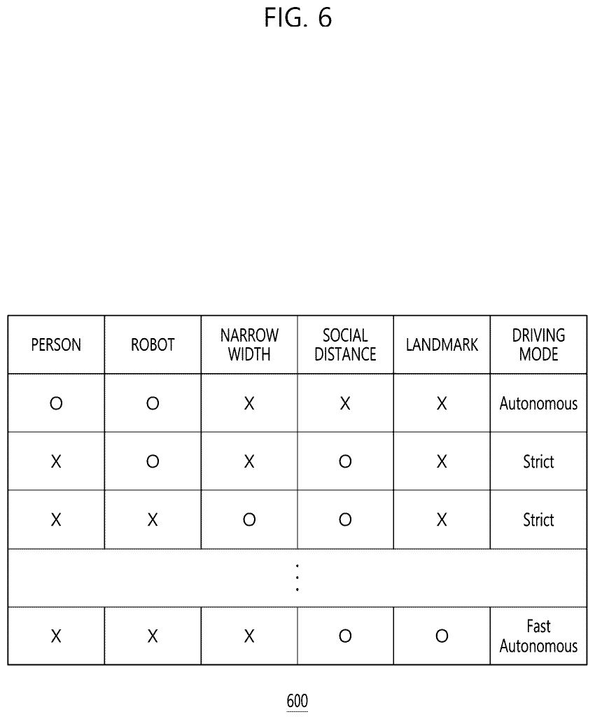

In some example embodiments, the robot may generate a response table including a response generated by the visual language model 530. Based on the response table, the robot may determine the driving mode 540. An example in which the robot determines a driving mode based on the response table is described later in detail with reference to FIG. 6.

FIG. 6 is a diagram illustrating an example of a response table 600 according to some example embodiments of the present disclosure. In some example embodiments, the response table 600 may include responses to queries associated with a plurality of driving mode determination factors. For example, in an image (for example, 510 of FIG. 5), a response of “yes” is generated for “Are there many people?” (additionally or alternatively, “Are there any people?) and “Is there a robot?”, and a response of “yes” or “no” may be generated for “Is the passage narrow?”, “Is the social distance between robot and human enough?”, and “Is there a fast sign?” (additionally or alternatively, “Is there a slow sign?”). In this case, a response to each of the plurality of queries may be reflected in the response table 600. Referring to FIG. 6, for example, a response of “yes” may be reflected as “O” and a response of “no” may be reflected as “X”.

In some example embodiments, based on the response table 600, any one among a preset (or alternatively, given) plurality of driving modes may be determined. Here, each of the preset (or alternatively, given) plurality of driving modes may correspond to each combination of responses included in the response table 600. For example, when, in the response table 600, “person” and “robot” items are “yes” and “narrow width”, “social distance”, and “landmark” are “no”, the driving mode may be determined as “autonomous mode”. As another example, when, in the response table 600, “person”, “narrow width”, and “landmark” items are “no” and “robot” and “social distance” items are “yes”, the driving mode may be determined as “strict driving mode (strict mode)”. Additionally, weights of responses for respective driving mode determination factors of the robot may be differently applied. In this case, the driving mode of the robot may also be determined according to a score reflecting weights of responses for the respective driving mode determination factors.

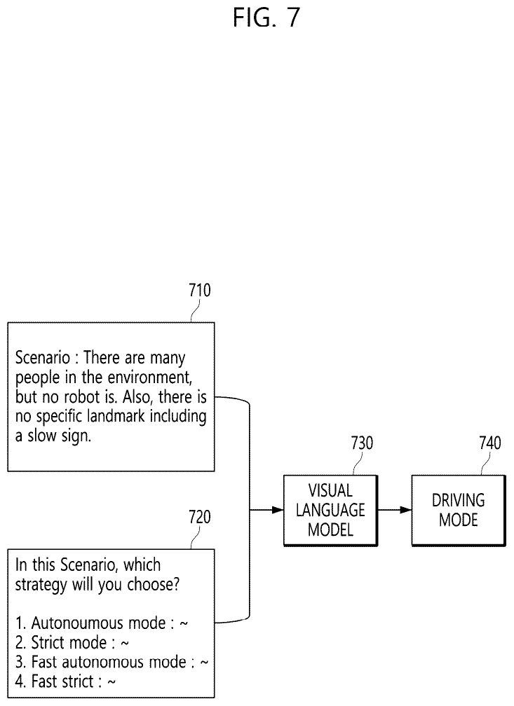

FIG. 7 is a diagram illustrating an example in which a driving mode 740 of a robot is determined according to some example embodiments of the present disclosure. In some example embodiments, the robot may generate, based on an image captured by the robot, a scenario 710 describing the image, and may transmit the scenario 710 to the information processing system 230 or a server. For example, the robot may generate, in a text form, a scenario 710 such as “There are many people in the environment, but no robot is. Also, there is no specific landmark including a slow sign.” based on the image by using a machine learning model. Here, the machine learning model may be pre-trained (or trained) to output text describing an image by using the image as an input.

In some example embodiments, a zero-shot-based visual language model 730 of the server may generate a response based on the scenario 710 and a query 720 received from the robot. Specifically, the query 720 generated by the robot may include a preset (or alternatively, given) plurality of driving modes (for example, Autonomous mode) and information describing each of the plurality of driving modes (for example, a definition and a condition for Autonomous mode). In this case, the visual language model 730 of the server may generate a response selecting a most appropriate driving mode for the scenario 710 given by the robot, based on information describing each of the plurality of driving modes. Here, the visual language model 730 may include a Large Language Model (LLM), but is not limited thereto. Accordingly, the robot may determine a driving mode 740 based on a response (for example, number 1 “Autonomous mode”) generated by the visual language model 730.

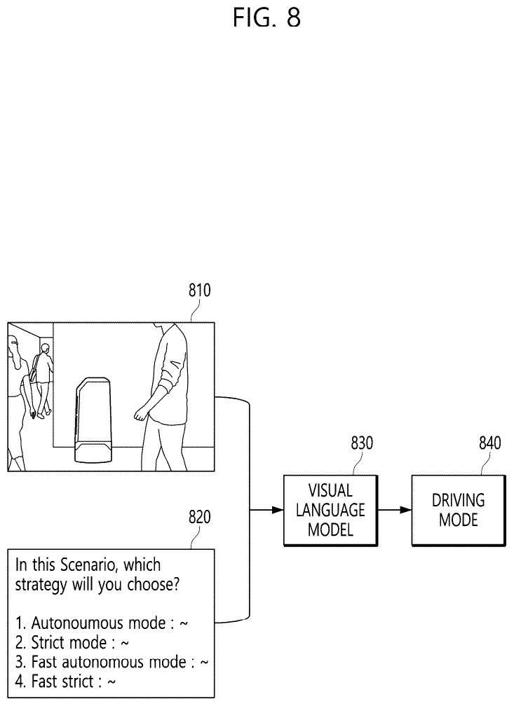

FIG. 8 is a diagram illustrating an example in which a driving mode 840 of a robot is determined according to some example embodiments of the present disclosure. In some example embodiments, the robot may transmit, to the information processing system 230 or a server, an image 810 captured while autonomously driving. In addition, the robot may transmit, to the information processing system 230 or the server, a query 820 including a preset (or alternatively, given) plurality of driving modes and information describing each of the plurality of driving modes.

In some example embodiments, a zero-shot-based visual language model 830 of the server may generate a response based on the image 810 and the query 820 received from the robot. Specifically, the visual language model 830 may understand a situation by analyzing the image 810. In addition, the visual language model 830 may generate a response selecting a most appropriate driving mode for a given situation, based on information describing each of the plurality of driving modes. Here, the visual language model 830 may include a large language-and-vision model (LLVM), but is not limited thereto. Accordingly, the robot may determine a driving mode 840 based on a response generated by the visual language model 830 of the server.

Through such a configuration, by using a zero-shot-based visual language model applicable to an actual environment even without learning a new dynamic object, surrounding situations of the robot may be understood. Accordingly, by determining and switching an appropriate driving mode according to a situation, driving efficiency of the robot may be improved, and a collision risk of the robot may be reduced.

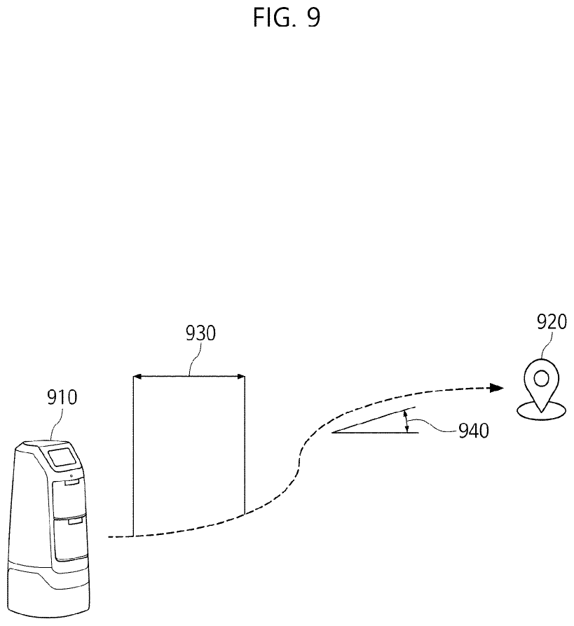

FIG. 9 is a diagram illustrating an example in which a driving mode of a robot 910 is determined according to some example embodiments of the present disclosure. In some example embodiments, the robot 910 may determine a driving mode of the robot 910 based on absolute position information. Specifically, when the robot 910 passes a specific area 930 on a driving path to a destination 920, in the specific area 930, the robot 910 may autonomously drive in a preset (or alternatively, given) driving mode. For example, when the specific area 930 is a dark room, even when the robot 910 captures an image with a camera, a surrounding environment of the robot 910 in the image may be difficult to recognize. As described above, when the robot 910 has difficulty in determining a driving mode based on a response received from the information processing system 230 or a server, the robot 910 may drive according to a preset (or alternatively, given) driving mode (for example, a strict driving mode) corresponding to the specific area 930.

In some example embodiments, the robot 910 may determine a driving mode of the robot 910 based on characteristics of a path. Specifically, when the robot 910 passes a slope 940 or a terrain obstacle on a driving path to a destination 920, the robot 910 may autonomously drive in a preset (or alternatively, given) driving mode. For example, when the robot 910 passes the slope 940 on the driving path, there is a risk that the robot 910 overturns according to a speed of the robot 910. As described above, when the robot 910 is unable to determine a driving mode of the robot 910 based on a response received from the information processing system 230 or the server, the robot 910 may autonomously drive according to the preset (or alternatively, given) driving mode based on a slope or an obstacle on the driving path.

In some example embodiments, in a section other than the above-described areas (e.g., the specific area 930 and the slope 940), the robot 910 may be free in communication with the server (e.g., may determine an effective driving mode based on a response from the server). In this case, the robot 910 may determine a driving mode in real time based on a response received from the server.

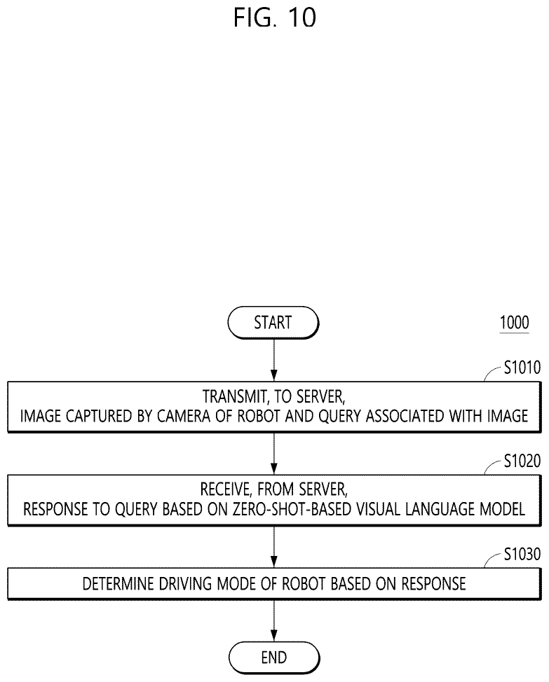

FIG. 10 is a flowchart illustrating an example of a method 1000 according to some example embodiments of the present disclosure. In some example embodiments, the method 1000 may be performed by at least one processor of a robot. The method 1000 may be described as beginning with transmitting, by the at least one processor, an image captured by a camera of the robot and a query associated with the image to a server (S1010). Here, the query may include a query about a driving mode determination factor. For example, the driving mode determination factor may include at least one of whether a person exists (or is present), whether a robot exists (or is present), whether a landmark exists (or is present), whether a width of a passage is narrower than a predetermined (or alternatively, given) value, or whether a social distance between the robot and a person is smaller than a predetermined (or alternatively, given) value.

Thereafter, the at least one processor may receive, from the server, a response to the query, based on a visual language model (e.g., a zero-shot-based visual language model) (S1020). Thereafter, the at least one processor may determine a driving mode of the robot based on the response (S1030). Specifically, the processor may determine any one among a preset (or alternatively, given) plurality of driving modes. Here, at least one of a driving speed of the robot or an autonomous driving allowance level of the robot may be differently set in each of the plurality of driving modes.

According to some example embodiments, the processor may control a speed of the robot based on the determined driving mode (determined in operation S1030). For example, the robot may include a motive system (e.g., an internal combustion engine, an electric motor, etc.) and/or a braking system (e.g., a hydraulic braking system, an electro-hydraulic braking system, an electromechanical braking system, an electromechanical actuator, an electrical braking system, a brake-by-wire braking system, etc.). In response to determining a driving mode that authorizes or specifies an increased speed (e.g., relative to a current speed of the robot), the processor may control the motive system (e.g., by causing/triggering actuation of one or more actuators in the motive system) to increase the speed of the robot. In response to determining a driving mode that only authorizes or specifies a decreased speed (e.g., relative to the current speed of the robot), the processor may control the motive system and/or the braking system (e.g., by causing/triggering actuation of one or more actuators in the motive system and/or the braking system) to decrease the speed of the robot.

Additionally or alternatively, according to some example embodiments, the processor may control a steering angle of the robot based on the determined driving mode (determined in operation S1030). For example, the robot may include a steering system (e.g., a hydraulic steering system, an electro-hydraulic steering system, an electromechanical steering system, an electromechanical actuator, an electrical steering system, a drive-by-wire steering system, etc.). In response to determining a driving mode that authorizes or specifies a greater autonomous driving allowance level (e.g., relative to a current autonomous driving allowance level of the robot), the processor may control the steering system (e.g., by causing/triggering actuation of one or more actuators in the steering system) to permit a greater range of steering angles relative to a curvature of the path (e.g., less conformity to the path). In response to determining a driving mode that only authorizes or specifies a decreased autonomous driving allowance level (e.g., relative to the current autonomous driving allowance level of the robot), the processor may control the steering system (e.g., by causing/triggering actuation of one or more actuators in the steering system) to permit a decreased range of steering angles relative to the curvature of the path (e.g., stricter conformity to the path).

In some example embodiments, the at least one processor may generate, based on the response, a response table including responses for respective driving mode determination factors. Additionally or alternatively, the at least one processor may obtain, receive (e.g., from another device, such as the information processing system 230, a server, a cloud system, the input/output device 320, etc.) and/or store the response table (e.g., in the memory 312). The processor may determine any one among the preset (or alternatively, given) plurality of driving modes based on the response table. In determining a driving mode of the robot, weights of responses for respective driving mode determination factors may be different.

In some example embodiments, the processor may transmit, to the server, a scenario describing an image based on the image. In this case, the query may include information describing the preset (or alternatively, given) plurality of driving modes. In addition, the processor may determine any one among the plurality of driving modes based on a response generated based on (e.g., in response to) the scenario and the query.

In some example embodiments, the query may include information describing the preset (or alternatively, given) plurality of driving modes. In this case, the processor may determine any one among the plurality of driving modes based on a response generated based on (or in response to) the image and the query.

In some example embodiments, when the processor receives the same response (or similar responses) from the server a predetermined (or alternatively, given) number of times, the processor may determine a driving mode of a robot. In addition, when the processor is unable to determine a driving mode of the robot based on the response, the processor may determine a driving mode of the robot based on absolute position information of the robot. Alternatively, when the processor is unable to determine a driving mode of the robot based on the response, the processor may determine a driving mode of the robot based on a slope or an obstacle on a driving path of the robot.

In some example embodiments, the response may be generated based on a characteristic of a specific object in an image. Additionally or alternatively, the response may be generated based on an operation of a specific object in an image.

In some example embodiments, the response may be generated for a plurality of different queries. That is, the above-described S1010 and S1020 may be repeated. For example, a query about a driving mode based on an image generated by the robot (or a scenario describing the image) is first transmitted to the server, and the server may transmit a response to the query to the robot. Thereafter, the robot transmits, to the server, a subsequent query about whether a person included in the image is a young child or an elderly person, and the server may transmit a response to the query to the robot. In addition, the robot transmits, to the server, a subsequent query about whether a person included in the image is moving or standing, and the server may transmit a response to the query to the robot. The robot may determine a driving mode based on responses to three different queries. A query generated by the robot is not predetermined (or alternatively, given) and may be dynamically generated in real time, and by combining responses to a plurality of dynamically generated queries, a more sophisticated determination of a driving mode in real time is possible.

According to some example embodiments, operations described herein as being performed by the robot 110, the robot 410, and/or the robot 910 may be performed by processing circuitry. For example, each of the robot 110, the robot 410, and/or the robot 910 may be implemented by the robot 210.

In some example embodiments, the processing circuitry may perform some operations (e.g., the operations described herein as being performed by the visual language model 130, the visual language model 530, the VQA model, the LLVM model and/or the LLM model implemented by the information processing system 230, and/or the machine learning model implemented by the robot 210) by artificial intelligence and/or machine learning. As an example, the processing circuitry may implement an artificial neural network (e.g., the visual language model 130, the visual language model 530, the VQA model, the LLVM model and/or the LLM model implemented by the information processing system 230, and/or the machine learning model implemented by the robot 210) that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as Convolutional Neural Networks (CNN), Recurrent Neural Networks (RNN) optionally including Long Short-Term Memory (LSTM) units and/or Gated Recurrent Units (GRU), Stacking-based Deep Neural Networks (S-DNN), State-Space Dynamic Neural Networks (S-SDNN), deconvolution networks, Deep Belief Networks (DBN), and/or Restricted Boltzmann Machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Herein, a machine learning model (e.g., the visual language model 130, the visual language model 530, the VQA model, the LLVM model and/or the LLM model implemented by the information processing system 230, and/or the machine learning model implemented by the robot 210) may have any structure that is trainable, e.g., with training data. For example, the machine learning model may include an artificial neural network, a decision tree, a support vector machine, a Bayesian network, a genetic algorithm, and/or the like. The machine learning model will now be described by mainly referring to an artificial neural network, but some example embodiments are not limited thereto. Non-limiting examples of the artificial neural network may include a Convolution Neural Network (CNN), a Region based Convolution Neural Network (R-CNN), a Region Proposal Network (RPN), a Recurrent Neural Network (RNN), a Stacking-based Deep Neural Network (S-DNN), a State-Space Dynamic Neural Network (S-SDNN), a deconvolution network, a Deep Belief Network (DBN), a Restricted Boltzmann Machine (RBM), a fully convolutional network, a Long Short-Term Memory (LSTM) network, a classification network, and/or the like.

A tradeoff exists between efficiency of robot travel (e.g., delay to reach a destination) and collision risk (e.g., the risk of a collision between the robot and another object/robot or a person). For example, as the travel speed (e.g., robot speed and/or directness of a travel path) of the robot increases (as efficiency increases) the collision risk also increases. Also, while the collision risk is reduced when the travel speed (e.g., robot speed and/or directness of a travel path) of the robot decreases, this decrease in speed also reduces the efficiency.

Conventional devices and methods for controlling a robot involve setting a fixed travel speed for a given area in which the robot travels. Such conventional devices and methods are unable to adapt to dynamic changes in the given area, resulting in robot travel that is inefficient in some scenarios (e.g., scenarios in which collision risk in the area is lower) and involves excessive collision risk in other scenarios (e.g., scenarios in which collision risk in the area is higher).

However, according to some example embodiments, improved devices and methods are provided for controlling a robot. For example, the improved devices and methods may involve using a visual language model to determine one among a plurality of different driving modes. The visual language model is capable of inferring a current state of an environment of the robot (e.g., based on an image of the environment), and of determining an appropriate driving mode based on the current state of the environment. Accordingly, the improved devices and methods are able to increase the travel speed (e.g., robot speed and/or directness of a travel path) of the robot in scenarios in which collision risk represented by the environment of the robot is lower, and decrease the travel speed (e.g., robot speed and/or directness of a travel path) of the robot scenarios in which collision risk represented by the environment of the robot is higher. Therefore, the improved devices and methods overcome the deficiencies of the conventional devices and methods to at least improve efficiency (e.g., reduce robot travel delay) and reduce collision risk.

The above-described method may be provided as a computer program stored in a non-transitory computer-readable recording medium for execution on a computer. The medium may continuously store computer-executable programs or temporarily store the programs for execution or download. In addition, the medium may include various recording means or storage means in which a single piece of hardware or several pieces of hardware are combined. The medium is not limited to a medium directly connected to any computer system, but may be distributed on a network. Examples of media may include magnetic media such as hard disks, floppy disks, and magnetic tapes, optical recording media such as CD-ROMs and DVDs, magneto optical media such as floptical disks, ROMs, RAMs, and flash memories, etc., and may be configured to store program instructions. In addition, examples of other media may include recording media and storage media which are managed by application stores that distribute applications, sites that supply or distribute various types of software, servers, and the like.

The methods, operations, or techniques of the present disclosure may also be implemented by various means. For example, such techniques may be implemented in hardware, firmware, software, or a combination thereof. Those of ordinary skill in the art will understand that various illustrative logical blocks, modules, circuits, and algorithm operations described in connection with the present disclosure may be implemented in electronic hardware, computer software, or a combination of both. In order to clearly describe the interchangeability of hardware and software, various illustrative components, blocks, modules, circuits, and operations have been described above generally in terms of their functionality. Whether such functionality is implemented as hardware or software depends on design requirements (or configurations) imposed on the specific application and overall system. Those skilled in the art may implement the described functionality in a variety of ways for each specific application, but such implementations should not be interpreted as departing from the scope of the present disclosure.

In a hardware implementation, the processing units used to perform the techniques may be implemented within one or more ASICs, DSPs, GPUs, Digital Signal Processing Devices (DSPDs), Programmable Logic Devices (PLDs), Field Programmable Gate Arrays (FPGAs), processors, controllers, microcontrollers, microprocessors, electronic devices, other electronic units designed to perform the functions described in the present disclosure, computers, or a combination thereof.

Accordingly, various illustrative logical blocks, modules, and circuits described in connection with the present disclosure may be implemented or performed by a general-purpose processor, DSP, ASIC, FPGA, or other programmable logic device, discrete gate or transistor logic, discrete hardware components, or any combination thereof designed to perform the functions described herein. The general-purpose processor may be a microprocessor, but, alternatively, the processor may be any processor, controller, microcontroller, or state machine. The processor may, in addition, be implemented as a combination of computing devices, for example, a DSP and a microprocessor, multiple microprocessors, one or more microprocessors in connection with a DSP core, or any other combination of configurations.

In a firmware and/or software implementation, the techniques may be implemented as instructions stored on a non-transitory computer-readable medium, such as Random Access Memory (RAM), Read-Only Memory (ROM), Non-Volatile Random Access Memory (NVRAM), Programmable Read-Only Memory (PROM), Erasable Programmable Read-Only memory (EPROM), Electrically Erasable PROM (EEPROM), flash memory, Compact Disc (CD), magnetic or optical data storage device. The instructions may be executed by one or more processors, and may cause the processor(s) to perform specific aspects of the functions described in the present disclosure.

When implemented in software, the techniques may be stored on a non-transitory computer-readable medium as one or more instructions or code or transmitted through the non-transitory computer-readable medium. The non-transitory computer-readable medium includes both computer storage media and communication media, including any medium that facilitates the transmission of a computer program from one location to another. The storage media may be any available media that may be accessed by a computer. As a non-limiting example, such non-transitory computer-readable media may include RAM, ROM, EEPROM, CD-ROM or other optical disk storage, magnetic disk storage or other magnetic storage devices, or any other medium that may be used to transfer or store desired program code in the form of instructions or data structures and that may be accessed by a computer. In addition, any connection is appropriately performed by a computer-readable medium.

For example, when the software is transmitted from a website, server, or other remote source by using a coaxial cable, fiber optic cable, twisted pair, Digital Subscriber Line (DSL), or wireless technologies such as infrared, radio, and microwave, the coaxial cable, fiber optic cable, twisted pair, digital subscriber line, or wireless technologies such as infrared, radio, and microwave are included within the definition of the medium. As used herein, the term disk and disc includes CD, laser disc, optical disc, Digital Versatile Disc (DVD), floppy disk, and Blu-ray disc, where disks typically reproduce data magnetically, while discs reproduce data optically using lasers. Combinations of the above should also be included within the scope of computer-readable media.

Software modules may reside in RAM memory, flash memory, ROM memory, EPROM memory, EEPROM memory, registers, hard disk, removable disk, CD-ROM, or any other form of storage medium known in the art. An exemplary storage medium may be connected to the processor such that the processor may read information from the storage medium or write information to the storage medium. Alternatively, the storage medium may be integrated into the processor. The processor and the storage medium may exist (or be included) in an ASIC. The ASIC may exist (or be included) in a user terminal. Alternatively, the processor and the storage medium may exist as separate components in a user terminal.

Although the above-described examples have been described as using aspects of the presently disclosed subject matter in one or more standalone computer systems, the present disclosure is not limited thereto and may be implemented in connection with any computing environment, such as network or distributed computing environments. Furthermore, aspects of the subject matter in the present disclosure may be implemented across multiple processing chips or devices, and storage may similarly be affected across multiple devices. Such devices may include Personal Computers (PCs), network servers, and portable devices.

In the present specification, although the present disclosure has been described in connection with some example embodiments, various modifications and changes may be made within a scope not departing from a scope of the present disclosure, which may be understood by those having ordinary skill in the art to which the inventive concepts of the present disclosure belong. In addition, such modifications and changes should be considered as falling within a scope of the appended claims attached to the present specification.

1. A method for determining a robot driving mode, the method being performed by at least one processor included in a robot, and the method comprising:
transmitting, to a server, an image captured by a camera of the robot and a query associated with the image;
receiving, from the server, a response to the query based on a visual language model; and
determining a driving mode of the robot based on the response.

2. The method of claim 1, wherein the query comprises a query about a driving mode determination factor.

3. The method of claim 2, wherein the driving mode determination factor comprises at least one of:
whether a person exists;
whether a robot exists;
whether a landmark exists;
whether a width of a passage is narrower than a predetermined value; or
whether a social distance between the robot and a person is smaller than a predetermined value.

4. The method of claim 2, further comprising:
generating a response table based on the response, the response table including responses for respective driving mode determination factors,
wherein the determining of the driving mode of the robot includes determining any one among a preset plurality of driving modes based on the response table.

5. The method of claim 4, wherein weights of the responses are different for the respective driving mode determination factors.

6. The method of claim 1, further comprising:
transmitting, to the server, a scenario describing the image, the scenario being based on the image.

7. The method of claim 6, wherein
the query includes information describing a preset plurality of driving modes; and
the determining of the driving mode of the robot includes determining one among the preset plurality of driving modes based on a response generated based on the scenario and the query.

8. The method of claim 1, wherein
the query includes information describing a preset plurality of driving modes; and
the determining of the driving mode of the robot includes determining one among the preset plurality of driving modes based on a response generated based on the image and the query.

9. The method of claim 1, wherein the determining of the driving mode of the robot comprises:
determining one among a preset plurality of driving modes, at least one of a driving speed of the robot or an autonomous driving allowance level of the robot is differently set in each of the preset plurality of driving modes.

10. The method of claim 1, wherein the determining of the driving mode of the robot comprises:
determining the driving mode of the robot when a same response is received from the server a predetermined number of times.

11. The method of claim 1, wherein the determining of the driving mode of the robot comprises:
determining the driving mode of the robot based on absolute position information of the robot when the driving mode of the robot is not determined based on the response.

12. The method of claim 1, wherein the determining of the driving mode of the robot comprises:
determining the driving mode of the robot based on a slope or an obstacle on a driving path of the robot when the driving mode of the robot is not determined based on the response.

13. The method of claim 1, wherein the response is generated based on a characteristic of a specific object in the image.

14. The method of claim 1, wherein the response is generated based on an operation of a specific object in the image.

15. A non-transitory computer-readable recording medium recording instructions that, when executed by a computer, cause the computer to perform the method according to claim 1.

16. A robot, comprising:
a communication module;
a memory; and
at least one processor connected to the memory, the at least one processor being configured to execute at least one computer-readable program included in the memory to cause the robot to,
transmit, to a server, an image captured by a camera of the robot and a query associated with the image,
receive, from the server, a response to the query based on a visual language model, and
determine a driving mode of the robot based on the response.
